(19) United States
(12) Patent Application Publication
(10) Pub. No.: US 2007/0033855 A1
(43) Pub. Date: Feb. 15, 2007

(54) Flexible segment fishing pole

(76) Inventor: Man Young Jung, Pasadena, CA (US)

Correspondence Address: LAW OFFICES OF CLEMENT CHENG, 17220 NEWHOPE STREET #127, FOUNTAIN VALLEY, CA, 92708, US

(21) Appl. No.: 11/583,261

(22) Filed: Oct. 19, 2006

Related U.S. Application Data
(63) Continuation-in-part of application No. 10/985,675, filed on Nov. 11, 2004.

(51) Int. Cl. A01K 87/02; A01K 87/00

(52) U.S. Cl. 43/18.1 CT; 43/18.1 R

(57) ABSTRACT

An improvement to a fishing pole is disclosed, the improvement including a multi-flex segment that separates a resilient rod of the fishing pole into lower and upper portions. Both the upper and lower portions are interconnected through the multi-flex segment. A rigid retractable sleeve is positionable in either a disengaged position away from the multi-flex segment or in an engaged position over the multi-flex segment. In the disengaged position, the sleeve is positioned so that it covers part of the lower section of the rod, but none of the multi-flex segment, thereby allowing the multi-flex segment to flex more freely during casting, for example. In its engaged position, however, the sleeve is positioned to cover the multi-flex segment completely, interconnecting in a rigid fashion the upper portion of the rod to the lower portion of the rod.

### CROSS REFERENCE TO RELATED APPLICATION

This application is a continuation-in-part application of Jung, Man U.S. application Ser. No. 10/985,675 filed Nov. 11, 2004 entitled Flexible Segment Fishing Pole.

### FIELD OF THE INVENTION

The present invention relates generally to fishing poles, and, more particularly, is directed towards a fishing pole with flexible segment for greater casting distances.

### DISCUSSION OF RELATED ART

Prior art fishing poles have been developed to increase the distance that a fisherman can cast a fishing lure. A longer cast results in a longer time in the water for the fishing lure, per cast, thereby increasing the odds that a fish will be attracted to the lure and will bite. Moreover, a longer cast results in less competition for fish in waters where other fisherman cannot cast, thereby increasing the odds that a fisherman who can cast a greater distance will catch fish. Indeed, certain larger fish prefer deeper waters, and therefore the fisherman who can cast out to deeper water from, say, the edge of a lake or the end of a pier, has improved odds of catching such larger fish.

The ideas of sectional fishing rods or poles have been presented for various purposes and patents referenced in relation to the present invention are as follows:

U.S. Pat. No. 499,779 to Cable shows a solution to make a travel fishing rod that is folded up in a compact article. Secure hinges can fold rod sections but ferrules may slide over the hinges to stop the articulations keeping the rod extended. Hinges either make or break the extension of the rod.

U.S. Pat. No. 3,245,169 to Kennel suggests another travel fishing rod with spring tension hinge for the same purpose of the Cable patent, the difference being pivotal spring hinges connect rod sections and fixed ferrules secure the rod sections with the assistance of spring tension. Spring hinges make or break the extension of the rod.

U.S. Pat. No. 1,982,910 to Forbes et al. was brought to the attention of the applicant. One might particularly imagine mop handling while fishing and further his thought to adapt a handle of mop to a casting rod. Forbes' handle patent utilizes the directional bending characteristics of flat spring (30) allowing a linear flexure of mop head to achieve an ergonomically correct posture of the cleaner and sliding sleeve (18) makes or breaks the resilient bending of the rod sections assisted by coiled spring (17) in line with the handle sections. While it is up to a second inventive thought to blend such distanced technologies, subsequent fishing rod patents used strikingly similar components many times over. No technical literature has been found about unifying an angular mop section to facilitate surface cleaning and a flexing rod section for improved projection of fish line.

For example, U.S. Pat. No. 2,351,734 to Backe shows in-line springs between adjacent rod sections. However, multitudes of springs need to be used to give a specific flexing performance controlled by a tension strand for varying the resiliency of the fishing rod.

U.S. Pat. No. 2,538,338 to Sturdevant employs a full spring rod fitted on a casting handle. The principle portion of the rod is a single coil spring with a line of forward extension. Internal flat springs normally limit the flexure of the spring. But there is offered no hint of how to regulate the flexibility of the long spring rod once it is fixed to the handle.

U.S. Pat. No. 2,559,934 to Briney discloses a snubbing action spring mated with Z-shaped bends of a rod, which flexes at the spring and Z-bends but resists its recoiling tendency to accurately cast the bait. Forming the Z section in the rod compensates lack of control in the flexibility of spring. Such deformation may not be universally applied to different blank rods available or adds a costly process that might be saved otherwise.

U.S. Pat. No. 2,759,288 to Bratek utilizes a yoke, which is a sophisticated spring tension device in a casting rod. The spring is limited to make linear flexing movements in the frame of yoke requiring a separate adjusting knob adding to the complexity and weight to the rod contrary to the desirable free and sensitive flexes before and after fish bites.

U.S. Pat. No. 3,216,144 to Vojinov provides an oversized external spring threaded over the entire fishing rod handle and extends distally to carry fishing line. The spring-rod member may be turned concentrically about the handle shifting all the way to the handle butt to make a compact rod to carry about. Through this method of extension or retraction, the spring provides varying flexure to the rod for use in bait casting or fly casting. Because a spring is made of hard material like metal whipping motion during bait casting with the spring-rod will be too heavy for a sensitive bait control and may result in unsafe casting actions.

U.S. Pat. No. 3,507,069 to Borba, Sr. suggests interchangeable spring interconnection between a casting rod and a handle member. The screw-on spring is replaceable with another spring to change the degree of flexure of the casting rod. Extra set of springs needs to be prepared.

U.S. Pat. No. 4,656,773 to Klefbeck on Apr. 14, 1987 teaches an energy efficient casting rod. Such a device has a complicated set of pulleys and cabling, and as such is both somewhat difficult to use and maintain, and is considerably longer than an average fishing pole. As such, it may only be used in certain open locations where the threat of snagging another fisherman or bystander is low. Further, such a device is awkward to use due to its extended length.

Therefore, there is a need for an easy-to-use and easy-to-maintain fishing pole that can provide casts of greater distances to the average user. Such a needed fishing pole would include an improvement that could be readily built into the fishing pole during its (upon its initial) manufacture, or retrofitted onto an existing fishing pole. The present invention accomplishes these objectives.

### SUMMARY OF THE INVENTION

In a fishing rod that has a resilient rod, a handle, and a reel, an improvement includes a flexible segment that separates the resilient rod into lower and upper portions. Both the upper and lower portions are interconnected through the flexible segment, which is preferably a flexible spring or the like. The flexible spring is uniquely shaped into an hourglass with two larger convolutions at the opposite ends connected by narrower middle convolutions so that two separated flexing points are provided in the spring where either one or both of the flexing points is activated or deactivated by using a sliding sleeve that adjusts the spring flexure from a full flexure through a semi-flexible to an inflexible state.

The rod also has a number of guides spaced along the rod to suspend a line fastened to the tip where a hooked lure or bait is attached. The rigid retractable sleeve is positionable in a disengaged position away from the flexible segment or in an engagement position over the flexible segment or a semi-engagement position in between. In the disengaged position, the sleeve is positioned so that it covers part of the lower section of the rod, but none of the flexible segment, thereby allowing the flexible segment to flex more freely during casting, for example. In its engagement position, however, the sleeve is positioned to cover the flexible segment completely, interconnecting in a rigid fashion the upper portion of the rod to the lower portion of the rod. As such, the upper portion is not free to pivot with respect to the lower portion, and as such is more characteristic of a conventional fishing pole.

In use, the user sets the sleeve in the disengaged position and casts the lure. The user may utilize the greater flexibility of the fishing rod to cast the lure a greater distance than he could without the increased flexibility of the rod, either by casting overhead or sideways. Once the lure has been cast, the user then positions the sleeve into the engaged position, greatly reducing the flexibility of the fishing rod and making it more suitable for use in setting a hook during a fish strike at the lure and then reeling in the catch. As needed, the user may choose to set the sleeve in its semi-engagement position to control an undesirable event of excessive vibrations depending on the degree of a rod's own flexing characteristics.

Thus, the present invention may be easily retrofitted onto an existing fishing pole, or integrated into the manufacture of a new fishing pole. The present invention provides the user with a choice between greater pole flexibility, which is useful to cast a lure a relatively great distance, and conventional pole flexibility for a user to select after casting. The device is easy to use and easy to maintain. The present device is, moreover, relatively inexpensive to manufacture, and does not include complicated pulleys or excessive mechanisms that can be difficult to use and maintain. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is an elevational illustration of a first embodiment of the invention, illustrating a fishing rod attachment having a flexible section and a rigid control sleeve in a disengaged position at a lower rod portion with a user's own stock rod being adapted to provide a partial sleeve mounting fitted into the flexible section;

FIG. 2 is a partial elevational view, illustrating the fishing rod of FIG. 1 made complete with a threaded blank rod for direct mounting of the control sleeve, which is depicted in both the disengaged position at the lower rod portion and, alternately, in an engagement position at the upper rod portion;

FIG. 3 is a cross sectional view of the fishing rod of FIG. 2 taken at the middle of the control sleeve in the corresponding disengaged and engaged positions seen toward the upper rod section of the fishing pole;

FIG. 4 is a partially cut away view of a flexible section according to a second embodiment of the invention showing a sleeve in a disengaged position at an upper rod portion as opposed to the lower rod position in the first embodiment shown in FIG. 2.

FIG. 5 is an elevational view of a flexible section according to a third embodiment of the invention showing a sleeve mounting having sleeve slots and engaging pins.

FIG. 6 is a partially cut away view of a flexible section according to a fourth embodiment of the invention showing a rigid retractable member in the shape of bar or rod extending in parallel with the flexible rod section.

### DETAILED DESCRIPTION OF THE PREFERRED EMBODIMENT

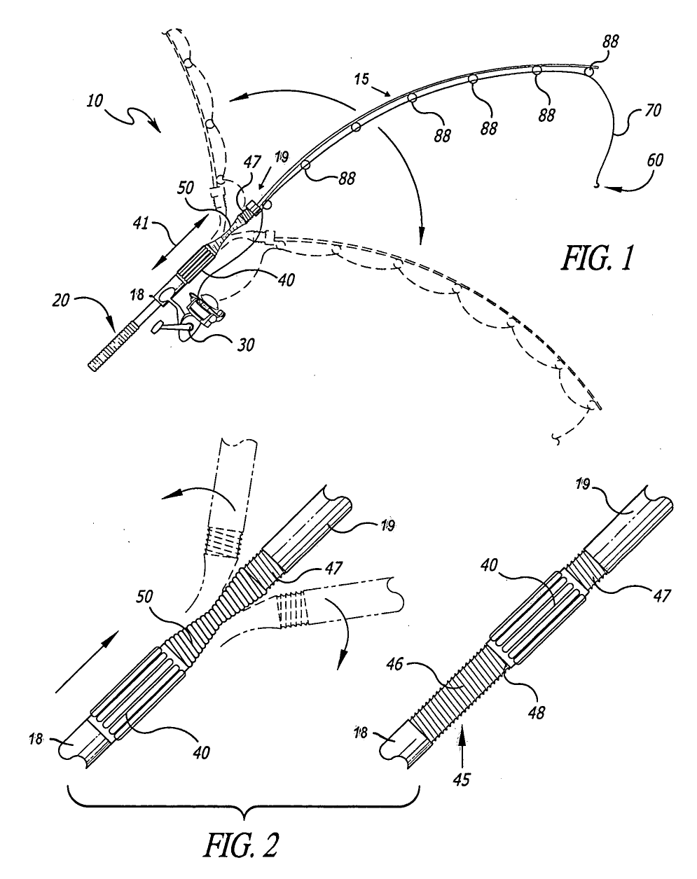

The present invention is an improved fishing rod 10 that has a resilient blank rod 15, a handle 20, and a reel 30 (FIG. 1). As with conventional fishing rods, rod 10 has a monofilament line 70 that is threaded from the reel 30 through a plurality of eyelets 88 fixed to the resilient blank rod 15 and terminates at a lure or hook 60. The fishing rod 10 of the present invention is separated into a lower portion 18 and an upper portion 19, each portion 18,19 being interconnected through a flexible segment 50.

In case where fishing rod 10 is specified as a retrofitting attachment, upper portion 19 may take the form of a short tubular adaptor for receiving and connecting stock rod 15 prepared by a user to lower portion 18 of rod 10 as depicted in FIG. 1.

In comparison, FIG. 2 shows upper portion 19 of FIG. 1 has been threaded near its proximal end and fixed at its tip to flexible segment 50 to offer a completed fishing rod product ready to bring to a fishing trip.

The flexible segment 50 may be a flexible spring (FIG. 2) or an elastomeric member such as a tubular section of changing diameters to have varying flexure points along the length or similar solid rod with tubular seats at both ends. The flexible segment can be a helical torsion spring. The flexible segment can be made of polymer, or metal. In addition, the flexible segment may be a hybrid of a metal coil and a thick rubberized coating of polymer on the coil, which can be made by dip or spray coatings as it is stretched by holding its opposite ends until they are cured. If a solid elastic rod is used, it is shaped to have a thicker middle area and narrowed end portions in order to provide two separated flex points in the rod for the purpose of the present invention described below.

The lower portion 18 and upper portion 19 may be fixed to the flexible segment 50 in a variety of ways known by those skilled in the art, such as by inserting the ends of each portion 18, 19 into a hollow cylindrical portion at each end of the flexible segment .50 and fixing the same in place with a plurality of set screws, for example (not shown). The preferred mode is to connect the upper portion and lower portion to the flexible segment by adhesive and a binding structure such as a laminate or other commercially available means for connecting fishing rod components.

Flexible spring 50 has an hourglass shape to provide two divided flex points defined by a reduced middle diameter. Among varying diameters of coils in a spring larger coils flex easier than the smaller coils resulting in varying degree of flexibility. Thus, spring 50 provides a unique flexure adjustment mechanism in an unprecedented tight space in cooperation with a control sleeve 40.

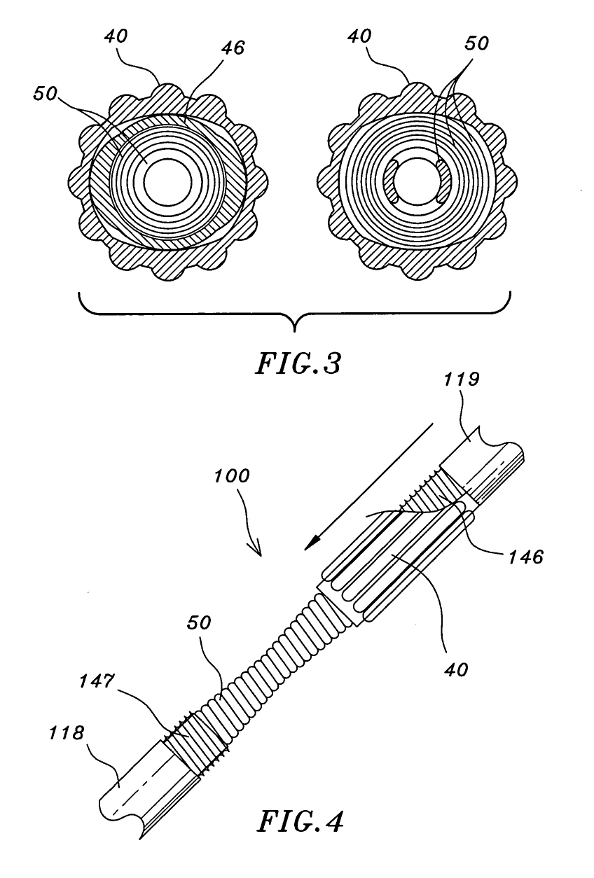

The control sleeve 40 is a rigid retractable member positionable along a sliding path 41 in a disengaged position or an engagement position as shown in FIGS. 2 and 3 or a semi-engagement position in between.

The sliding path is preferably straight but can also be curved. Where the retractable sleeve is arc shaped, the sliding path can also be arc shaped to accommodate the curved profile of the sleeve. The longitudinal axis of the sleeve 40 is co-aligned with the longitudinal axis of the resilient blank rod 15. In the disengaged position, the sleeve 40 is positioned so that it covers part of the lower section 18 of the rod 10 (FIG. 2), but none of the flexible segment 50, thereby allowing the flexible segment 50 to flex freely at both flex points during casting, for example. Therefore, the flexible segment 50 provides for a multi-action fishing rod with an extra action to the fishing rod 10 that already has a native action value by the rod material used for the upper portion. In casting, fast action rods are known to flex initially in the upper ⅓ of their length. Moderate and slow action rods flex in the upper ½ of their length and along the entire length, respectively. The result is that the upper portion 19 of the fishing rod 10 may pivot back and forth a greater distance than with a prior art fishing rod. In its engagement position, however, the sleeve 40 is positioned to enclose the flexible segment 50 completely leaving no part of segment 50 exposed, interconnecting in a rigid fashion the upper portion 19 to the lower portion 18. As such, the upper portion 19 is not free to pivot freely with respect to the lower portion 18, and as such is more characteristic of a conventional fishing pole.

The basic principle is that the sleeve 40 engages and disengages to allow the user a positive control between rigid and flexible states of a fishing pole. Further, the stiffened middle region of the flexible segment 50 provides an automatic semi-flexible state by the sleeve 40 enclosing approximately half or less the flexible segment 50 with only the distal flex point left to flex freely without requiring a precise manual positioning of the sleeve 40. The sleeve fixedly engages the upper portion of the fishing rod by a variety of connection means including magnetic, threads as at 46 and 47 in FIGS. 1 and 2, slotted engagement and combinations thereof.

A mounting means 45 for the sleeve 40 may include internal threads 48 on an inside surface of the sleeve 40 that engage lower portion threads 46 and upper portion threads 47, for example. In the threaded model, the upper and lower portions 19, 18 of the fishing rod 10 both have threads. The sleeve 40 engages upon the threads because the sleeve interior is also threaded according to the same pitch. As such, the sleeve 40 is spun around its longitudinal axis to assume the engaged or disengaged position. In this preferred embodiment, tightening the sleeve 40 by rotating results in rotational friction holding the sleeve 40 in place in either the engaged or disengaged position.

Parallel grooves can take the place of the internal threads 48 such that the internal threads 48 allows little or no rotation of the sleeve 40 during retraction and engagement. Also, parallel grooves or internal threads 48 can be omitted.

The internal threads of sleeve 40 may be formed locally near its opposite ends to engage the lower and upper portion threads 46, 47 equally well but with less rotational friction. Initially, the sleeve 40 may rest on the lower portion 18 of the rod 10 away from the flexible segment 50 until the angler has cast the lure. After serving its purpose, the flexible segment 50 may be deactivated by simply turning the sleeve 40 to bring the sleeve 40 engage the upper portion 19 encasing the whole segment 50.

Or the sleeve 40 may stop midway over the flexible segment 50 to permit only the uncovered one of the two flex points to be active adding about fifty percent of the total flexure to the rod 10.

FIG. 4 shows a fishing rod 100 according to a second embodiment of the invention wherein the engagement position of the control sleeve is reversed from that of the first embodiment. More specifically, an upper rod portion 119 has a major threaded seat 146 for receiving thereon the control sleeve 40 away from the flexible segment 50 while a lower rod portion 118 provides a mating portion 147 for threadedly engaging the leading edge of sleeve 40 to prevent it from rattling during casting. As is clear from the drawing, rod 100 is identical to the rod 10 except the directions of engagement as identified by an arrowhead and disengagement of the sleeve 40.

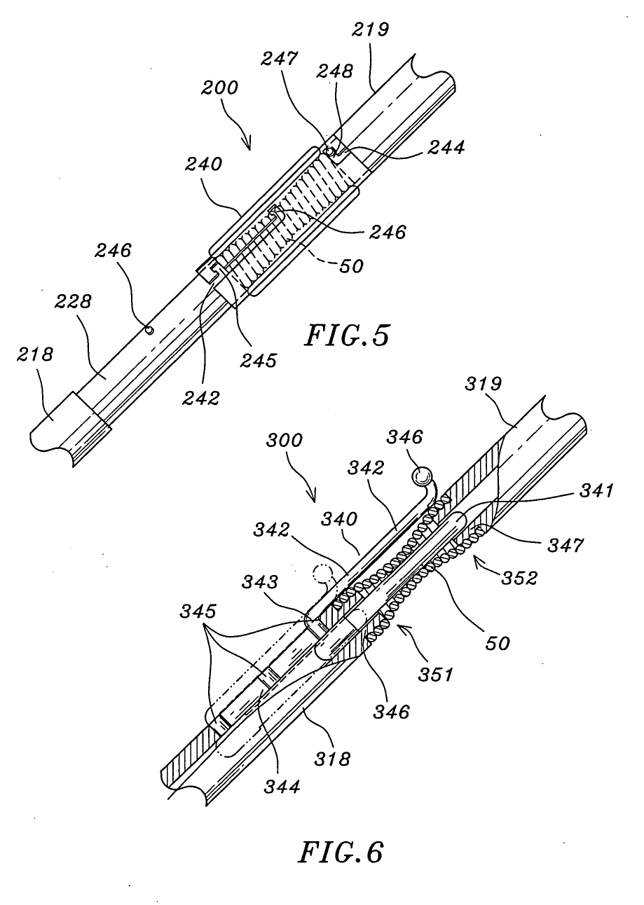

In the slotted model according to a third embodiment of the invention illustrated in FIG. 5, a fishing rod 200 comprises a lower rod portion 218 terminating with an elongated boss 228, which has a tip portion coaxially press fitted into the flexible segment 50. A cylindrical sleeve 240 is mounted slidably over the segment 50 as well as boss 228. The opposite end of the flexible segment 50 is fitted with an upper rod portion 219 also firmly attached in line with the lower rod portion 218. The sleeve 240 has two serial slots 242 and 244 that open to the opposite ends to engage pins or protrusions 246 and 247 mounted on the lower and upper rod portions 218 and 219, respectively. The upper slot 244 is shorter than the lower slot 242, which extends to the middle of the sleeve 240. In order to give the sleeve 240 positive shifts between engagement and disengaged positions and a midway position, the longer slot 242 has two short circumferential notches, one at 245 near the lower end of sleeve 240 and the other at 246 in the middle of the sleeve 240. In addition, the upper shorter slot 244 has a similar notch 248 to secure the sleeve 240 through its engagement with the pin 247 on the upper rod portion 219. The location of pin 246 on the lower rod portion 218 is determined in relation to the notches 245, 248 so that engagement of pin 246 with notch 245 sets the sleeve 240 in disengaged position from the flexible segment 50 while its engagement with notch 245 holds the sleeve 240 in semi-engagement position restricting half the flexible segment 50.

Where the sleeve 240 is mounted below the flexible segment 50 with pin 246 being snug in the notch 246 a user can turn the sleeve 240 slightly out of engagement with pin 246 to pull the sleeve up and then fix the sleeve notch 248 around the pin 247. Putting the pin 246 in the notch 245 causes only one of the two flex points of flexible segment 50 to be active resulting in half a flexure of segment 50 applied to the rod 200. Because the sleeve 240 has three distinctive locked positions with no resistance between the shifts flexure control of the rod 200 becomes speedy.

Where the sleeve 240 is mounted over the flexible segment 50 a user can pull the sleeve down and then fix the sleeve slot into the pin or protrusion shaped to receive the slot. The sleeve once engaged, provides support and reinforces the flexible segment 50 so that the flexible segment becomes a rigid segment.

In an alternative embodiment of the invention, the engagement position of the control sleeve 240 is reversed from that of the third embodiment. I.e., the boss 228 with pin 246 becomes a part of upper rod portion 219 as opposed to pin 247 being moved to the lower rod portion 218 with the longer slot 240 and shorter slot 244 changing positions as the control sleeve 240 reversed. Besides the positional changes the rest of the rod 200 remains the same. Thus, the sleeve 240, in its disengaged position for example, covers part of the upper portion 219 and none of the flexible segment 50. In such an embodiment, however, the sleeve 240 must be locked in the disengaged position so that gravity or the forces resulting during casting of the fishing rod 200 do not cause the sleeve 240 to slide down over the flexible segment 50 when such is not desired.

FIG. 6 illustrates a fourth embodiment of the present invention wherein a fishing rod 300 comprises a lower rod portion 318 made of a hollow blank rod to which a handle is attached at its lower end. The top end of the lower portion 318 is provided with a boss 346 of reduced diameter for insertion into an open end of the flexible segment 50. In order to form a positive abutment against the spring 50, the boss 346 of lower portion 318 may be threaded externally conforming to the helical extensions of the coil spring. An upper rod portion 319 is similarly provided with a lower boss 347 inserted threadedly into the other end of the spring 50 thereby providing two prominent flexing points as at 351 and 352 along the spring 50. Also, as an alternative method to reinforce the flexible segment 50, a rigid rod or latch 340 that slides between an engagement position that rigidly connects the upper rod portion 319 with the lower rod portion 318, and a disengaged position where the latch 340 is cleared from a restricting engagement with the spring 50. With latch 340 cleared, the lower and upper portions 318, 319 are joined together solely under the full resiliency of the spring 50. Latch 340 may be generally U shaped such as a clasp member, which has an elongated main shaft 341 and a parallel side arm 342. The arm 342 has a basal end 343 extending through an elongated slot 344 formed on the lower rod portion 318 to the proximal end of main shaft 341 and a top end bent near the distal end of shaft 341 away from the rod 300 to provide a handle 346 for easily sliding the latch 340 into the engaged or disengaged position. Three circumferential notches 341 from the slot 344 secure the control shaft 341 in each of the engagement, disengaged and semi-engagement positions by holding the latch 340 at the basal end 343. The latch 340 acts like a clip that firmly restricts a side of the flexible segment 50 at least partially both from interior and exterior thereof.

In use, the user sets the sleeve 40 in the disengaged position and casts the lure as in FIG. 2. However, the user may utilize the greater flexibility of the fishing rod 10 to cast the lure 60 a greater distance than he could without the increased flexibility of the rod 10. Once the lure 60 has been cast, the user then positions the sleeve 40 into the engaged position, greatly reducing the flexibility of the fishing rod 10 and making it more suitable for use in setting a hook during a fish strike at the lure 60 and reeling in the catch.

An another alternative mounting means 45 may be an annular ridge encircling one area of the lower portion 18 and another annular ridge encircling one area of the upper portion 19 (not shown), whereby annular grooves on the inside surface of the sleeve 40 engage the annular ridges and frictionally lock the sleeve 40 into the disengaged position or engaged position.

Yet another alternative mounting means 45 may be a magnetic catch in both the upper portion 19 or the lower portion 18 of the rod 10 (not shown), such that a sleeve 40 made from a rigid magnetically active metal or the like can be magnetically locked into either the engaged or disengaged position by slide such a sleeve 40 between positions manually.

Clearly, a wide variety of mounting means 45 may be incorporated into either new fishing rods 10 or retrofitted onto existing fishing rods 10. Moreover, a wide variety of flexible segments 50 may be utilized to accomplish the objectives of the present invention. For example, while a coiled spring is the preferred mode of the flexible segment 50, a rubber or other flexible elastomeric element or rod (not shown) may be used as the flexible segment 50. Further, the resilient rod blank 15 may be modified by cutting a plurality of grooves (not shown) into the rod blank 15, increasing the flexibility of the rod blank 15 in the portion with grooves. Thus, while a particular form of the invention has been illustrated and described, it will be apparent that various modifications can be made without departing from the spirit and scope of the invention. Accordingly, it is not intended that the invention be limited, except as by the appended claims.

1. In a fishing pole having a resilient rod, an improvement comprising:
a multi-flex segment extending in line with the resilient pole for separating and interconnecting a lower portion of the rod from an upper portion of the rod, the multi-flex segment having at least two separated high flexing areas; and
a rigid bar supported by the resilient rod to slide along the multi-flex segment between two or more locked positions including an engagement position for rigidly interconnecting the lower portion of the rod to the upper portion of the rod, thereby deactivating the flexible segment, a disengaged position fixed to the lower portion of the rod but not extending up over the multi-flex segment to increase the resiliency of the resilient rod by the full flexure of the multi-flex segment and a semi-engagement position for allowing a reduced number of the high flexing areas of the multi-flex segment to add just the corresponding amount of flexure to the whole fishing pole.

2. The fishing pole of claim 1 wherein the rigid bar comprises a tubular member for enclosing at least the multi-flex segment, the tubular member being mounted on the resilient pole portions through thread connections.

3. The fishing pole of claim 1 wherein the multi-flex segment is a coiled spring shaped like an hourglass to have varying flex points along its longitudinal axis and the rigid bar comprises a U-shaped bar member having two parallel arms slidable along a slotted area of the resilient pole for mating with the coiled spring at its interior as well as exterior sides between two or more locked positions in a clasping engagement.

4. The fishing pole of claim 3 wherein the rigid bar is made of fiberglass.

5. The fishing pole of claim 3 wherein the rigid bar is made of wood.

6. The fishing pole of claim 3 wherein the rigid bar is made of metal.

7. In a fishing pole having a resilient rod, an improvement comprising:
a multi-flex segment extending in line with the resilient pole for separating and interconnecting a lower portion of the rod from an upper portion of the rod, the multi-flex segment having at least two separated high flexing areas; and
a rigid retractable sleeve, the sleeve being positionable between two or more locked positions including an engaged position interconnecting the lower portion of the rod to the upper portion of the rod, thereby reinforcing the flexible segment, a disengaged position attached to the upper portion of the rod but not extending down over the multi-flex segment and a semi-engagement position for allowing a reduced number of the high flexing areas of the multi-flex segment to add just the corresponding amount of flexure to the whole fishing pole.

8. The fishing pole of claim 7 further comprising a sleeve mounting having at least two sleeve slots, and at least two engaging pins mounted on the rod, whereby the sleeve moves between the engaged and the disengaged positions when the sleeve slots engage and disengage with the engaging pins.

9. The fishing pole of claim 7 further comprising a sleeve mounting having screw threads, whereby twisting the sleeve moves the sleeve between the engaged and the disengaged positions.

10. The fishing pole of claim 7 wherein the sleeve can be locked into either the engaged or disengaged position.

11. In a fishing pole having a resilient rod, an improvement comprising:
a multi-flex segment extending in line with the resilient pole for separating and interconnecting a lower portion of the rod from an upper portion of the rod, the multi-flex segment having at least two separated high flexing areas; and
a rigid retractable member supported by the resilient rod to slide along the multi-flex segment between two or more locked positions including an engagement position interconnecting the lower portion of the rod to the upper portion of the rod, thereby reinforcing the flexible segment, a disengaged position attached to the lower portion of the rod but not extending up over the multi-flex segment to increase the resiliency of the resilient rod by the full flexure of the multi-flex segment and a semi-engagement position for allowing a reduced number of the high flexing areas of the multi-flex segment to add just the corresponding amount of flexure to the whole fishing pole.

12. The fishing pole of claim 11 wherein the rigid retractable member is formed as a bar.

13. The fishing pole of claim 11 wherein the rigid retractable member is formed as a rod.

14. The fishing pole of claim 11 further comprising a retractable member mounting having screw threads, whereby twisting the retractable member moves the retractable member between the engaged and the disengaged positions.

15. The fishing pole of claim 11 wherein the retractable member is a rigid sleeve, and further comprising a sleeve mounting having sleeve slots, and engaging pins mounted on the rod, whereby the sleeve moves between the engaged and the disengaged positions when the sleeve slots engage and disengage with the engaging pins.
